(19) United States
(12) Patent Application Publication
(10) Pub. No.: US 2026/0161471 A1
(43) Pub. Date: Jun. 11, 2026

(54) TASK PROCESSING METHOD, TASK SCHEDULING METHOD, COMPUTING DEVICE, AND COMPUTER STORAGE MEDIUM

(71) Applicant: CLOUD INTELLIGENCE ASSETS HOLDING (SINGAPORE) PRIVATE LIMITED, Singapore (SG)

(72) Inventors: Zhenyu HU, Hangzhou (CN); Wei LI, Hangzhou (CN); Tao LI, Hangzhou (CN)

(21) Appl. No.: 19/538,625

(22) Filed: Feb. 12, 2026

Related U.S. Application Data
(63) Continuation of application No. PCT/CN2024/109708, filed on Aug. 5, 2024.

(30) Foreign Application Priority Data
Sep. 7, 2023 (CN) 202311153677.4

(51) Int. Cl. G06F 9/50; G06F 9/48

(52) U.S. Cl. CPC G06F 9/5038; G06F 9/4881

(57) ABSTRACT

Embodiments of the present disclosure provide a task processing method, a task scheduling method, a computing device, and a computer storage medium. The task processing method includes: receiving a task processing request; creating, in response to the task processing request, a task group based on a resource required for a task; detecting whether a remaining resource of a container management system satisfies a running resource requirement of the task group; and sending a container group in the task group to a scheduling queue of the container management system when determining that the remaining resource of the container management system satisfies the running resource requirement of the task group, so that the container group is scheduled to a node of the container management system, and the task processing request is processed.

### CROSS-REFERENCE TO RELATED APPLICATION

The present disclosure is a continuation of International Application No. PCT/CN2024/109708, filed on Aug. 5, 2024, which claims priority to Chinese Patent Application No. 202311153677.4, filed with the China National Intellectual Property Administration on Sep. 7, 2023 and entitled “TASK PROCESSING METHOD, TASK SCHEDULING METHOD, COMPUTING DEVICE, AND COMPUTER STORAGE MEDIUM”. The disclosures of the aforementioned applications are hereby incorporated by reference in their entireties.

### TECHNICAL FIELD

Embodiments of the present disclosure relate to the field of computer technologies and, in particular, to a task processing method, a task scheduling method, a computing device and a computer storage medium.

### BACKGROUND

A database system, such as a data warehouse, is used to integrate, store, and analyze a large amount of structured and unstructured data. To improve availability of the database system, so that the database system can perform elastic scaling according to a load, the database system can be deployed on a container management system, such as Kubernetes, to store, by using the container management system, data that needs to be managed by the database system.

In the related art, generally, after receiving a task processing request of a user, the database system submits the task processing request to the container management system, and the container management system determines whether a current remaining resource of the container management system satisfies a resource required for processing the task processing request. If the current remaining resource satisfies the resource required for processing the task processing request, a container group used for processing the task processing request can be created, and the container group is placed in a scheduling queue, waiting for the container group to be scheduled to a node for running. If the current remaining resource cannot satisfy the resource required for processing the task processing request, the container management system intercepts the task processing request. In this case, the container group cannot be created, leading to a task processing failure.

### SUMMARY

Embodiments of the present disclosure provide a task processing method, a task scheduling method and apparatuses, a computing device, and a computer storage medium.

According to a first aspect, an embodiment of the present disclosure provides a task processing method, including:
receiving a task processing request;
creating, in response to the task processing request, a task group based on a resource required for a task;
detecting whether a remaining resource of a container management system satisfies a running resource requirement of the task group; and
sending a container group in the task group to a scheduling queue of the container management system when determining that the remaining resource of the container management system satisfies the running resource requirement of the task group, so that the container group is scheduled to a node of the container management system, and runs on the node of the container management system, and the task processing request is processed.

According to a second aspect, an embodiment of the present disclosure provides a task scheduling method, including:
receiving a container group by using a scheduling queue, where the container group is included in a task group, where the task group is created in response to a task processing request and based on a resource required for a task, and the container group is sent to the scheduling queue when it is detected that a remaining resource of a container management system satisfies a running resource requirement of the task group; and
scheduling the container group to a target node, so that the container group runs on the target node, and the task processing request is processed.

According to a third aspect, an embodiment of the present disclosure provides a task processing apparatus, including:
a request receiving module, configured to receive a task processing request;
a task group creation module, configured to create, in response to the task processing request, a task group based on a resource required for a task;
a detection module, configured to detect whether a remaining resource of a container management system satisfies a running resource requirement of the task group; and
a container group sending module, configured to send a container group in the task group to a scheduling queue of the container management system when it is determined that the remaining resource of the container management system satisfies the running resource requirement of the task group, so that the container group is scheduled to a node of the container management system, and the task processing request is processed.

According to a fourth aspect, an embodiment of the present disclosure provides a task scheduling apparatus, including:
a container group receiving module, configured to receive a container group by using a scheduling queue, where the container group is included in a task group, where the task group is created in response to a task processing request and based on a resource required for a task, and the container group is sent to the scheduling queue when it is detected that a remaining resource of a container management system satisfies a running resource requirement of the task group; and
a container group scheduling module, configured to schedule the container group to a target node, so that the container group runs on the target node, and the task processing request is processed.

According to a fifth aspect, an embodiment of the present disclosure provides a computing device, including a processing component and a storage component, where
the storage component stores one or more computer instructions; and the one or more computer instructions are used for being invoked and executed by the processing component, to implement the task processing method according to the first aspect, or implement the task scheduling method according to the second aspect.

According to a sixth aspect, an embodiment of the present disclosure provides a computer storage medium, storing a computer program, where when the computer program is executed by a computer, the task processing method according to the first aspect is implemented, or the task scheduling method according to the second aspect is implemented.

According to a seventh aspect, an embodiment of the present disclosure provides a computer program product, including a computer program, where when the computer program is executed by a computer, the task processing method according to the first aspect is implemented, or the task scheduling method according to the second aspect is implemented.

An embodiment of the present disclosure provides a task processing method, which is implemented by the technical solution: receiving a task processing request; creating, in response to the task processing request, a task group based on a resource required for a task; detecting whether a remaining resource of a container management system satisfies a running resource requirement of the task group; and sending a container group in the task group to a scheduling queue of the container management system when determining that the remaining resource of the container management system satisfies the running resource requirement of the task group, so that the container group is scheduled to a node of the container management system, and the task processing request is processed. A queuing queue is constructed at a periphery of the container management system, and the task processing request first queues up in the queuing queue. When it is detected that the remaining resource of the container management system satisfies the resource required for processing the task processing request, the container group used for the task processing request is sent to the container management system, and the container group is scheduled by the container management system, to avoid a failure in processing the task processing request, thereby improving task processing efficiency.

It is clearer and easier to understand these aspects or other aspects of the present disclosure in the following descriptions of embodiments.

### BRIEF DESCRIPTION OF DRAWINGS

In order to more clearly describe the technical solutions of embodiments of the present disclosure or the prior art, the following briefly describes the accompanying drawings required for describing the embodiments or the prior art. Apparently, the accompanying drawings in the following descriptions show some embodiments of the present disclosure, and a person of ordinary skill in the art may derive other drawings from the accompanying drawings without creative efforts.

FIG. 1 schematically shows a general architectural diagram of a container management system Kubernetes.

FIG. 2 schematically shows a flowchart of a task processing method according to an embodiment of the present disclosure.

FIG. 3 schematically shows a schematic diagram of a task processing method according to an embodiment of the present disclosure.

FIG. 4 schematically shows a flowchart of a task scheduling method according to an embodiment of this present disclosure.

FIG. 5 schematically shows a block diagram of a task processing apparatus according to an embodiment of the present disclosure.

FIG. 6 schematically shows a block diagram of a task scheduling apparatus according to an embodiment of the present disclosure.

FIG. 7 schematically shows a block diagram of a computing device according to an embodiment of the present disclosure.

### DESCRIPTION OF EMBODIMENTS

To enable a person skilled in the art to better understand solutions of the present disclosure, the following clearly and completely describes the technical solutions in embodiments of the present disclosure with reference to the accompanying drawings in the embodiments of the present disclosure.

Some procedures described in this specification, the claims and the foregoing accompanying drawings of the present disclosure include a plurality of operations that appear in a specific sequence. However, it should be clearly understood that these operations may not be performed in the sequence presented in this specification or may be performed in parallel. Sequence numbers of the operations such as 101 and 102 are merely used to distinguish different operations, and the sequence numbers themselves do not indicate any execution sequence. In addition, these procedures may include more or fewer operations, and these operations may be performed in sequence or in parallel. It should be noted that, descriptions such as “first” and “second” in this specification are used to distinguish different messages, devices, modules, and the like, do not indicate a sequence, and do not limit that “first” and “second” are of different types.

It should be noted that, user information (including but not limited to user device information and user personal information) and data (including but not limited to data used for analysis, stored data, and displayed data) involved in the present disclosure are both authorized by a user or fully authorized by all parties, and collection, use, and processing of related data need to comply with related laws, regulations, and standards of related countries and regions, and a corresponding operating entry is provided for the user to accept or reject the authorization.

The following clearly and completely describes the technical solutions in the embodiments of the present disclosure with reference to the accompanying drawings in the embodiments of the present disclosure. Apparently, the described embodiments are merely some rather than all of the embodiments of the present disclosure. Based on the embodiments of the present disclosure, all other embodiments obtained by a person skilled in the art without creative efforts shall fall within the protection scope of the present disclosure.

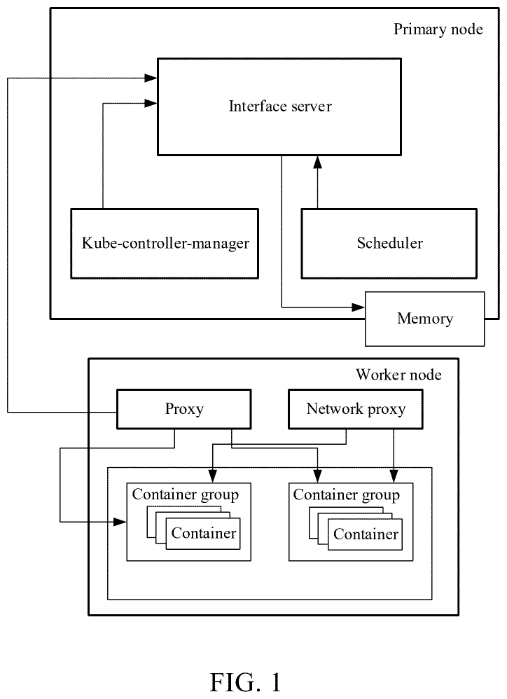

FIG. 1 schematically shows a general architectural diagram of a container management system Kubernetes.

As shown in FIG. 1, in Kubernetes, nodes in a cluster are divided into a primary node (Master) and at least one worker node (Node). The Master and the Node may be physical machines or virtual machines in a cloud environment. The cloud environment is specifically a computing cluster that includes at least one cloud computing device (for example, a central server). In some implementations, the Master and the Node may alternatively be physical machines or virtual machines in an edge environment. The edge environment is specifically a computing cluster that includes at least one edge computing device (for example, an edge server). In some other implementations, the Master and the Node may alternatively be end devices or virtual machines on the end devices. It should be noted that, the Master and the Node may be physical machines or virtual machines in a same environment, or may be physical machines or virtual machines in different environments. For example, the Master may be the physical machine in the cloud environment, and the Node may be the physical machine in the edge environment.

A group of processes that are related to cluster management, for example, processes such as an interface server (kube-apiserver), a kube controller manager (kube-controller-manager), a scheduler (kube-scheduler), and a memory (etcd), are running on the Master. The kube-apiserver relies on the etcd to store data. The Master may implement management capabilities, such as resource management, pod (container group) scheduling, elastic scaling, security control, and error correction, on the entire cluster through these processes.

A process of an application program runs on the Node which provides a resource required for running the process of the application program. The process of the application program specifically runs in a container of pod. Service processes, for example, processes such as a proxy (kubelet) and a network proxy (kube-proxy), further run on the Node. The Node implements Pod creation, Pod starting, Pod restarting, Pod destruction, and load balancing through these service processes.

An example in which a Kubernetes cluster includes one Master and one Node is described in FIG. 1. In some implementations, the Kubernetes cluster may include a plurality of Nodes. In this way, applications may be deployed on the plurality of Nodes in a distributed manner. Further, the Kubernetes cluster may also include a plurality of Masters. When a Master is faulty, another Master may be enabled, to ensure high availability.

A database system, such as a data warehouse, is used to integrate, store, and analyze a large amount of structured and unstructured data. To improve availability of the database system, so that the database system can perform elastic scaling according to a load, the database system can be deployed on a container management system, such as Kubernetes, to store, by using the container management system, the data that needs to be managed by the database system.

In the related art, generally, after receiving a task processing request of a user, the database system submits the task processing request to the container management system, and the container management system determines whether a current remaining resource of the container management system satisfies a resource required for processing the task processing request. If the current remaining resource satisfies the resource required for processing the task processing request, a container group used for processing the task processing request can be created, and the container group is placed in a scheduling queue, waiting for the container group to be scheduled to a node for running. If the current remaining resource cannot satisfy the resource required for processing the task processing request, the container management system intercepts the task processing request. In this case, the container group cannot be created, leading to a task processing failure.

To resolve the technical problems existing in the related art, an embodiment of the present disclosure provides a task processing method, which is implemented by the technical solution: receiving a task processing request; creating, in response to the task processing request, a task group (PodGroup) based on a resource required for a task; detecting whether a remaining resource of a container management system satisfies a running resource requirement of the task group; and sending a container group in the task group to a scheduling queue of the container management system when determining that the remaining resource of the container management system satisfies the running resource requirement of the task group, so that the container group is scheduled to a node of the container management system, and the task processing request is processed. A queuing queue is constructed at a periphery of the container management system, and the task processing request first queues up in the queuing queue. When it is detected that the remaining resource of the container management system satisfies the resource required for processing the task processing request, the container group used for the task processing request is sent to the container management system, and the container group is scheduled by the container management system, to avoid a failure in processing the task processing request, thereby improving task processing efficiency.

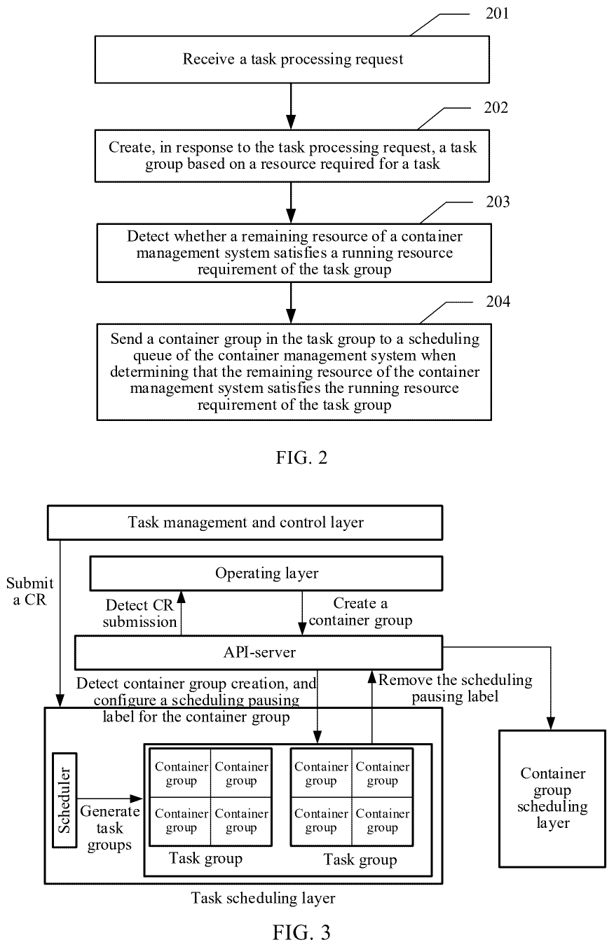

FIG. 2 schematically shows a flowchart of a task processing method according to an embodiment of the present disclosure. As shown in FIG. 2, the task processing method may include the following steps.
201: Receive a task processing request.
202: Create, in response to the task processing request, a task group based on a resource required for a task.
203: Detect whether a remaining resource of a container management system satisfies a running resource requirement of the task group.
204: Send a container group in the task group to a scheduling queue of the container management system when determining that the remaining resource of the container management system satisfies the running resource requirement of the task group, so that the container group is scheduled to a node of the container management system, and the task processing request is processed.

The task processing method provided in an embodiment of the present disclosure may be performed by a database system.

According to an embodiment of the present disclosure, the task processing request may include, for example, bigdata analysis, a processing task, an artificial intelligence processing task.

According to an embodiment of the present disclosure, a required resource quantity may be carried in the task processing request, and the required resource quantity may refer to a quantity of resources that need to be consumed for processing the task processing request. The resources may include, for example, a computing resource and a storage resource.

According to an embodiment of the present disclosure, after obtaining the task processing request, the database system may obtain the required resource quantity carried in the task processing request from the task processing request, and create the task group according to the required resource quantity.

According to an embodiment of the present disclosure, the task group has the running resource requirement. The running resource requirement may be a quantity of resources that needs to be provided by the container management system for running of the container group in the task group. The running resource requirement may match the required resource quantity. For example, the running resource requirement may be greater than or equal to the required resource quantity.

According to an embodiment of the present disclosure, after the task group is created, the task group may be first placed in a queuing queue of the database system, and then a current remaining resource quantity of the container management system is obtained.

According to an embodiment of the present disclosure, when it is determined that the current remaining resource quantity of the container management system is greater than the running resource requirement of the task group, it indicates that the remaining resource quantity of the container management system can support running of the task group. In this case, the task group may be dequeued, that is, the container group in the task group is sent to the scheduling queue of the container management system.

According to an embodiment of the present disclosure, after the container group in the task group is sent to the scheduling queue of the container management system, the container management system may perform a scheduling strategy thereof, to schedule the container group to a worker node in the container management system, and the worker node provides a resource for the container group, so that the container group can run to process the task processing request.

According to an embodiment of the present disclosure, after the task group is created based on the resource required for the task, the task processing method further includes:
placing the created and generated task group in a queuing queue of the database system.

According to an embodiment of the present disclosure, detecting whether the remaining resource of the container management system satisfies the running resource requirement of the task group may be specifically implemented as:
searching the queuing queue for determining whether there currently exists a waiting task group waiting to be scheduled, where a creation time point of the waiting task group is earlier than that of the task group;
if there currently exists the waiting task group waiting to be scheduled, determining a first scheduling priority of the waiting task group and a second scheduling priority of the task group; and
when the second scheduling priority is higher than the first scheduling priority, detecting whether the remaining resource of the container management system satisfies the running resource requirement of the task group.

According to an embodiment of the present disclosure, there may be a plurality of task groups in the queuing queue, and each task group may separately correspond to a different task processing request.

According to an embodiment of the present disclosure, each task group may be configured with a different priority. A resource may be preferentially allocated to a high-priority task group, and the high-priority task group is preferentially dequeued to be sent to the scheduling queue of the container management system, to be scheduled and run.

According to an embodiment of the present disclosure, the priority of the task group may be determined according to a priority of the task processing request.

According to an embodiment of the present disclosure, if the first scheduling priority is higher than the second scheduling priority, a running resource may be preferentially configured for the waiting task group. If the first scheduling priority is equal to the second scheduling priority, the running resource may be first configured for the waiting task group according to a first-in-first-out rule.

According to an embodiment of the present disclosure, the task processing method further includes:
allocating a first resource that satisfies the running resource requirement to the task group, to run, after the container group in the task group is scheduled to the node of the container management system, the container group by using the first resource.

According to an embodiment of the present disclosure, allocating the first resource that satisfies the running resource requirement to the task group may be implemented as: in the container management system, marking the first resource as belonging to the task group and temporarily not performing actual resource configuration; and after scheduling the container group in the task group to the node, running the container group by using the first resource that is marked as belonging to the task group.

According to an embodiment of the present disclosure, the task processing method further includes:
determining a second resource remaining in the container management system;
dividing the second resource into a third resource and a fourth resource separately according to the first scheduling priority and the second scheduling priority; and
allocating the third resource to the waiting task group, and allocating the fourth resource to the task group.

According to an embodiment of the present disclosure, to avoid a waiting time period of a low-priority waiting task group being excessively long, during resource allocation, a fair allocation strategy may be adopted. In other words, for the second resource remaining in the container management system, the second resource is evenly allocated to each task group according to a weight based on a priority of each task group.

According to an embodiment of the present disclosure, for dividing the second resource, the first scheduling priority and the second scheduling priority may be first converted into the weights, and then the weights are accumulated to obtain a weight sum.

After the weight sum is obtained by calculating, a resource ratio of each task group may be obtained based on a ratio of a weight to the weight sum, so that a resource quantity obtained by each task group may be calculated according to the resource ratio.

According to an embodiment of the present disclosure, even allocation of a remaining resource quota of the container management system may be implemented by using a priority as a weight. In this way, to some extent, it can be ensured that the high-priority task group can obtain more resources, and the low-priority task group is not completely ignored, to avoid the waiting time period of the low-priority waiting task group being excessively long.

According to an embodiment of the present disclosure, creating, in response to the task processing request, the task group may be specifically implemented as:
creating, in response to the task processing request, a plurality of task groups.

When determining that the remaining resource of the container management system satisfies the running resource requirement of the task group, sending the container group in the task group to the scheduling queue of the container management system includes:
when determining that the remaining resource of the container management system satisfies a running resource requirement of at least one task group of the plurality of task groups, sending the container group in the at least one task group to the scheduling queue of the container management system.

According to an embodiment of the present disclosure, for processing of tasks related to bigdata and artificial intelligence, the tasks are usually complex, and the plurality of task groups need to be created to process the complex tasks.

When the task processing request needs to be processed by the plurality of container groups, generally, a requirement for the resource quantity is also relatively high. In this case, to satisfy running resource requirements of all container groups, the plurality of container groups corresponding to the task processing request need to queue up in the queuing queue for a long time, to wait for resource allocation. In this way, a waiting time period for task processing is relatively long.

In an embodiment of the present disclosure, when the remaining resource of the container management system satisfies a running resource requirement of any container group in the task group, the container group for which the running resource requirement is satisfied may be first dequeued, so that this container group can be scheduled to the node, run on the node, and process some processing tasks that this container group is responsible for. In this way, a waiting time period for the resource can be shortened, and limited resources are fully used for task processing, to avoid a waiting resource deadlock when a plurality of container groups are used to perform task processing.

According to an embodiment of the present disclosure, after the task group is created, the task processing method further includes:
configuring a scheduling pausing label for the container group in the task group.

When determining that the remaining resource of the container management system satisfies the running resource requirement of the task group, the method further includes:
removing the scheduling pausing label configured for the container group in the task group.

Sending the container group in the task group to the scheduling queue of the container management system includes:
sending the container group in the task group to the scheduling queue of the container management system in response to the scheduling pausing label being removed.

According to an embodiment of the present disclosure, after the created and generated task group is placed in the queuing queue, the scheduling pausing label may be configured on the container group in the task group. When the container group in the task group is marked as being scheduling paused, the container group in the task group can be placed in a cache and temporarily does not participate in further scheduling.

According to an embodiment of the present disclosure, configuring a scheduling pausing label for the container group in the task group may be specifically implemented as:
when detecting that the remaining resource of the container management system does not satisfy the running resource requirement of the task group, configuring the scheduling pausing label for the container group in the task group.

According to an embodiment of the present disclosure, the container group in the task group may be configured with the scheduling pausing label when the remaining resource quantity of the container management system is less than the running resource requirement of the task group, but this is not limited thereto. The container group in the task group may also be configured with the scheduling pausing label when there is a high-priority task group whose priority is higher than the priority of the task group in the queuing queue.

According to an embodiment of the present disclosure, the scheduling pausing label can be removed when it is determined that the remaining resource of the container management system is greater than or equal to the running resource requirement of the task group.

FIG. 3 schematically shows a schematic diagram of a task processing method according to an embodiment of the present disclosure.

As shown in FIG. 3, the task processing method provided in this embodiment of the present disclosure may be divided into four layers on a logic level, which are respectively a task management and control layer, an operating layer, a task scheduling layer, and a container group scheduling layer.

After a user submits a task processing request at a console of a database system, the task management and control layer receives the task processing request, then obtains metadata information in the task processing request, then converts a task into a Kubernetes CR (Kubernetes customized resource) according to the metadata information, and submits the Kubernetes CR to an API-server. Metadata information of the task may include, for example, information such as a task name, a task description, a task type, and a required resource quantity of the task.

The task scheduling layer may detect the API-server. After CR creation in the API-server is detected, a specified quantity of container groups may be created according to the metadata information included in the CR.

The task scheduling layer may first create a task group (PodGroup) by using a scheduler. The task group may include a plurality of container groups (Pods), and one task group corresponds to one task processing request. After a case in which a container group is created is detected, a scheduling pausing label may be first configured for the container group, and the container group is sent to a queuing queue.

The queuing queue first allocates the container group to a task group to which the container group belongs, and then the queuing queue allocates a remaining resource quota of a container management system to the task group in the queue according to a specific algorithm. There may be two resource allocation algorithms. A first resource allocation algorithm is a priority scheduling algorithm. When a resource is allocated according to the priority scheduling algorithm, a priority of the task group is considered. In other words, a high-priority task group first obtains an applied resource; and when the priorities are the same, the resource is allocated in a first-come-first-allocated sequence. A second resource allocation algorithm is a weighted fair scheduling algorithm. Each task group uses its own priority as a weight, so that the remaining resource of the management system is evenly allocated. After the task group obtains the resource, the resource is further allocated to the container groups inside the task group. When the running resource requirement for a container group inside the task group is satisfied, the container group may be dequeued, and a scheduling pausing label on Pod (container group) is removed. When the resource obtained by the task group cannot satisfy a container group inside the task group, the container group queue up in the task group.

A container group with a scheduling pausing label may be first placed in a cache and does not participate in a scheduling strategy. When the scheduling pausing label is removed, the container group may be sent to a scheduling queue of the container management system, to execute scheduling logic of the container management system.

The task processing method provided in this embodiment of the present disclosure performs expansion based on a scheduler of the container management system, and a layer of a queuing queue is encapsulated before original scheduling. Only a container group that is scheduled through the queuing queue can enter the scheduler of the container management system to complete the final scheduling. This solution can dock with the scheduler of the container management system, to support queuing based on a task level and perform resource allocation based on an operating priority perception, thereby improving resource allocation efficiency and task processing efficiency.

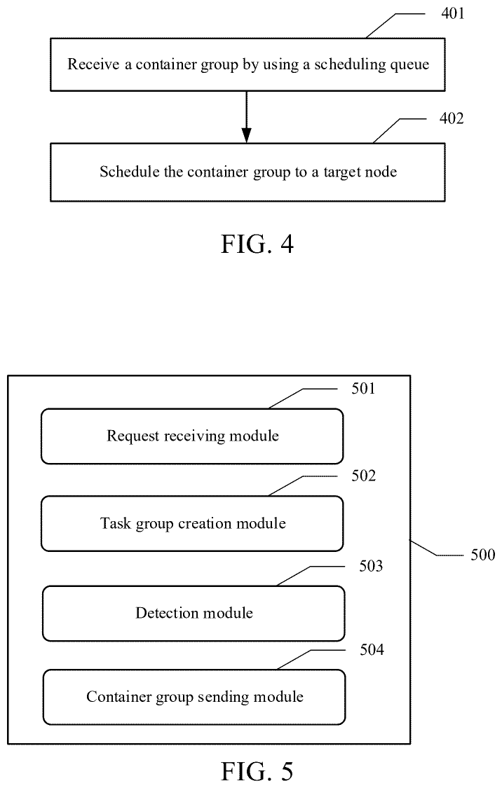

FIG. 4 schematically shows a flowchart of a task scheduling method according to an embodiment of the present disclosure. As shown in FIG. 4, the task scheduling method may specifically include the following steps.
401: Receive a container group by using a scheduling queue, where the container group is included in a task group, where the task group is created in response to a task processing request and based on a resource required for a task, and the container group is sent to the scheduling queue when it is detected that a remaining resource of a container management system satisfies a running resource requirement of the task group.
402: Schedule the container group to a target node, so that the container group runs on the target node.

FIG. 5 schematically shows a block diagram of a task processing apparatus according to an embodiment of the present disclosure. As shown in FIG. 5, the task processing apparatus 500 may include:
a request receiving module 501, configured to receive a task processing request;
a task group creation module 502, configured to create, in response to the task processing request, a task group based on a resource required for a task;
a detection module 503, configured to detect whether a remaining resource of a container management system satisfies a running resource requirement of the task group; and
a container group sending module 504, configured to send the container group in the task group to a scheduling queue of the container management system when it is determined that the remaining resource of the container management system satisfies the running resource requirement of the task group, so that the container group is scheduled to a node of the container management system, and the task processing request is processed.

According to an embodiment of the present disclosure, the task processing apparatus 500 further includes:
a queue writing module, configured to place the created and generated task group in a queuing queue of a database system.

According to an embodiment of the present disclosure, the detection module includes:
a searching submodule, configured to search the queuing queue for determining whether there currently exists a waiting task group waiting to be scheduled, where a creation time point of the waiting task group is earlier than that of the task group;
a first determining submodule, configured to determine a first scheduling priority of the waiting task group and a second scheduling priority of the task group, if there currently exists the waiting task group waiting to be scheduled; and
a detection submodule, configured to detect whether the remaining resource of the container management system satisfies the running resource requirement of the task group when the second scheduling priority is higher than the first scheduling priority.

According to an embodiment of the present disclosure, the task processing apparatus 500 further includes:
a configuration module, configured to allocate a first resource that satisfies the running resource requirement to the task group, to run, after the container group in the task group is scheduled to the node of the container management system, the container group by using the first resource.

According to an embodiment of the present disclosure, the task processing apparatus 500 further includes:
a first determining module, configured to determine a second resource remaining in the container management system;
a division module, configured to divide the second resource into a third resource and a fourth resource separately according to the first scheduling priority and the second scheduling priority; and
a resource allocation module, configured to allocate the third resource to the waiting task group, and allocate the fourth resource to the task group.

According to an embodiment of the present disclosure, the task group creation module 502 includes:
a task group creation submodule, configured to create, in response to the task processing request, a plurality of task groups.

According to an embodiment of the present disclosure, the container group sending module 504 includes:
a first container sending submodule, configured to: when it is determined that the remaining resource of the container management system satisfies a running resource requirement of at least one task group of the plurality of task groups, send the container group in the at least one task group to the scheduling queue of the container management system.

According to an embodiment of the present disclosure, the task processing apparatus 500 further includes:
a label configuration module, configured to configure a scheduling pausing label for the container group in the task group.

According to an embodiment of the present disclosure, the task processing apparatus 500 further includes:
a label removal module, configured to remove the scheduling pausing label configured for the container group in the task group.

According to an embodiment of the present disclosure, the container group sending module 504 includes:
a second container sending submodule, configured to send the container group in the task group to the scheduling queue of the container management system in response to the scheduling pausing label being removed.

According to an embodiment of the present disclosure, the label configuration module includes:
a label configuration unit, configured to configure the scheduling pausing label for the container group in the task group when it is detected that the remaining resource of the container management system does not satisfy the running resource requirement of the task group.

The task processing apparatus in FIG. 5 can perform the task processing method in the embodiment shown in FIG. 1. Implementation principles and technical effects thereof are not described herein again. A specific implementation of an operation performed by each module and each unit of the task processing apparatus in the foregoing embodiments is described in detail in the embodiments related to the method, and details are not described herein.

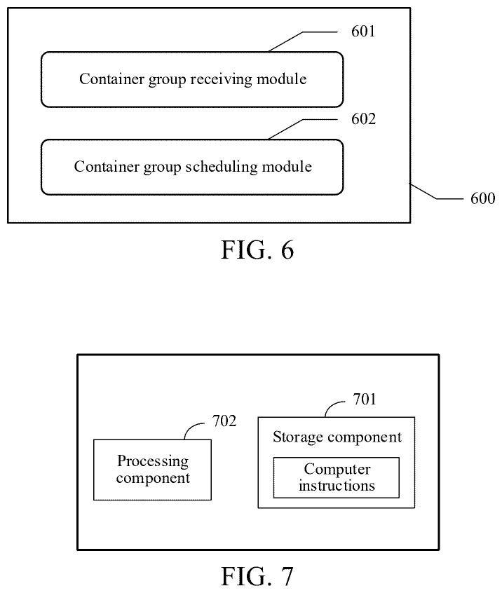

FIG. 6 schematically shows a block diagram of a task scheduling apparatus according to an embodiment of the present disclosure. As shown in FIG. 6, the task scheduling apparatus 600 may include:
a container group receiving module 601, configured to receive a container group by using a scheduling queue, where the container group is included in a task group, where the task group is created in response to a task processing request and based on a resource required for a task, and the container group is sent to the scheduling queue when it is detected that a remaining resource of a container management system satisfies a running resource requirement of the task group; and
a container group scheduling module 602, configured to schedule the container group to a target node, so that the container group runs on the target node, and the task processing request is processed.

The task scheduling apparatus in FIG. 6 can perform the task scheduling method in the embodiment shown in FIG. 4. Implementation principles and technical effects thereof are not described herein again. A specific implementation of an operation performed by each module and each unit of the task scheduling apparatus in the foregoing embodiments is described in detail in the embodiments related to the method, and details are not described herein.

In a possible design, the task processing apparatus and the task scheduling apparatus provided in the embodiments of the present disclosure may be implemented as a computing device. As shown in FIG. 7, the computing device may include a storage component 701 and a processing component 702.

The storage component 701 stores one or more computer instructions, where the one or more computer instructions are invoked and executed by the processing component 702, to implement the task processing method and the task scheduling method provided in the embodiments of the present disclosure.

Certainly, the computing device may necessarily further include another component, such as an input/output interface and a communication component. The input/output interface provides an interface between the processing component and a peripheral interface module, and the foregoing peripheral interface module may be an output device, an input device, or the like. The communication component is configured to facilitate communication between the computing device and another device in a wired or wireless manner.

The computing device may be a physical device or an elastic computing host provided by a cloud computing platform or the like. In this case, the computing device may refer to a cloud server, and the foregoing processing component, storage component, and the like may be basic server resources leased or purchased from the cloud computing platform.

When the computing device is the physical device, the computing device may be implemented as a distributed cluster formed by a plurality of servers or terminal devices, or may be implemented as a single server or a single terminal device.

An embodiment of the present disclosure further provides a computer-readable storage medium, storing a computer program, where when the computer program is executed by a computer, the task processing method and the task scheduling method provided in the embodiments of the present disclosure can be implemented.

An embodiment of the present disclosure further provides a computer program product, including a computer program, where when the computer program is executed by a computer, the task processing method and the task scheduling method provided in the embodiments of the present disclosure can be implemented.

The processing component in the foregoing corresponding embodiments may include one or more processors to execute computer instructions, to complete all or some steps in the foregoing methods. Certainly, the processing component may alternatively be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components, to perform the foregoing methods.

The storage component is configured to store various types of data to support operations in the device. The storage component may be implemented by any type of volatile or non-volatile storage device or a combination thereof, for example, a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

A person skilled in the art can clearly understand that for convenience and conciseness of description, for specific working processes of the foregoing systems, apparatuses and units, reference may be made to the corresponding processes in the foregoing method embodiments, and details are not described herein again.

The foregoing described apparatus embodiments are merely examples. The units described as separate parts may or may not be physically separated and the parts displayed as units may or may not be physical units, which may be located in one position or may be distributed on a plurality of network units. Some or all of the modules may be selected based on actual requirements to achieve objectives of the solutions of the embodiments. A person of ordinary skill in the art may understand and implement the embodiments without creative efforts.

Through the foregoing descriptions on the implementations, a person skilled in the art can clearly learn that all implementations may be implemented by using software in combination with a necessary universal hardware platform, and certainly, may alternatively be implemented by hardware. Based on such an understanding, the foregoing technical solutions essentially or the part contributing to the prior art may be implemented in a form of a software product. The computer software product may be stored in a computer-readable storage medium, such as a ROM/RAM, the hard disk, or the optical disc, and includes several instructions for instructing a computer device (which may be a personal computer, a server, a network device, or the like) to perform the methods described in the embodiments or some parts of the embodiments.

Finally, it should be noted that, the foregoing embodiments are merely used for describing the technical solutions of the present disclosure, but are not intended to limit the present disclosure. Although the present disclosure is described in detail with reference to the foregoing embodiments, a person of ordinary skill in the art should understand that, modifications may still be made to the technical solutions described in the foregoing embodiments, or equivalent replacements may be made to the part of the technical features in the technical solutions; and such modifications or replacements will not cause the essence of corresponding technical solutions to depart from the spirit and scope of the technical solutions in the embodiments of the present disclosure.

What is claimed is:

1. A task processing method, applied to a database system, wherein the method comprises:
receiving a task processing request;
creating, in response to the task processing request, a task group based on a resource required for a task;
detecting whether a remaining resource of a container management system satisfies a running resource requirement of the task group; and
sending a container group in the task group to a scheduling queue of the container management system when determining that the remaining resource of the container management system satisfies the running resource requirement of the task group, so that the container group is scheduled to a node of the container management system, and the task processing request is processed.

2. The method according to claim 1, further comprising:
placing the created and generated task group in a queuing queue of the database system, wherein
the detecting whether a remaining resource of a container management system satisfies a running resource requirement of the task group comprises:
searching the queuing queue for determining whether there currently exists a waiting task group waiting to be scheduled, wherein a creation time point of the waiting task group is earlier than that of the task group;
in response to the waiting task group waiting to be scheduled currently existing, determining a first scheduling priority of the waiting task group and a second scheduling priority of the task group; and
when the second scheduling priority is higher than the first scheduling priority, detecting whether the remaining resource of the container management system satisfies the running resource requirement of the task group.

3. The method according to claim 2, further comprising:
allocating a first resource that satisfies the running resource requirement to the task group, to run, after the container group in the task group is scheduled to the node of the container management system, the container group by using the first resource.

4. The method according to claim 2, further comprising:
determining a second resource remaining in the container management system;
dividing the second resource into a third resource and a fourth resource separately according to the first scheduling priority and the second scheduling priority; and
allocating the third resource to the waiting task group, and allocating the fourth resource to the task group.

5. The method according to claim 1, wherein the creating, in response to the task processing request, a task group comprises:
creating, in response to the task processing request, a plurality of task groups, wherein
the sending a container group in the task group to a scheduling queue of the container management system when determining that the remaining resource of the container management system satisfies the running resource requirement of the task group comprises:
when determining that the remaining resource of the container management system satisfies a running resource requirement of at least one task group of the plurality of task groups, sending the container group in the at least one task group to the scheduling queue of the container management system.

6. The method according to claim 1, wherein after the creating a task group, the method further comprises:
configuring a scheduling pausing label for the container group in the task group;
when determining that the remaining resource of the container management system satisfies the running resource requirement of the task group, the method further comprises:
removing the scheduling pausing label configured for the container group in the task group; and
the sending a container group in the task group to a scheduling queue of the container management system comprises:
sending the container group in the task group to the scheduling queue of the container management system in response to the scheduling pausing label being removed.

7. The method according to claim 6, wherein the configuring a scheduling pausing label for the container group in the task group comprises:
when detecting that the remaining resource of the container management system does not satisfy the running resource requirement of the task group, configuring the scheduling pausing label for the container group in the task group.

8. A task scheduling method, comprising:
receiving a container group by using a scheduling queue, wherein the container group is comprised in a task group, wherein the task group is created in response to a task processing request and based on a resource required for a task, and the container group is sent to the scheduling queue when it is detected that a remaining resource of a container management system satisfies a running resource requirement of the task group; and
scheduling the container group to a target node, so that the container group runs on the target node, and the task processing request is processed.

9. A computing device, comprising a processing component and a storage component, wherein
the storage component stores one or more computer instructions; and the one or more computer instructions are used for being invoked and executed by the processing component, to implement the task processing method according to claim 1.

10. The computing device according to claim 9, wherein the processing component is further configured to place the created and generated task group in a queuing queue of the database system, and wherein the processing component is specifically configured to:
search the queuing queue for determining whether there currently exists a waiting task group waiting to be scheduled, wherein a creation time point of the waiting task group is earlier than that of the task group;
in response to the waiting task group waiting to be scheduled currently existing, determine a first scheduling priority of the waiting task group and a second scheduling priority of the task group; and
when the second scheduling priority is higher than the first scheduling priority, detect whether the remaining resource of the container management system satisfies the running resource requirement of the task group.

11. The computing device according to claim 10, wherein the processing component is further configured to:
allocate a first resource that satisfies the running resource requirement to the task group, to run, after the container group in the task group is scheduled to the node of the container management system, the container group by using the first resource.

12. The computing device according to claim 10, wherein the processing component is further configured to:
determine a second resource remaining in the container management system;
divide the second resource into a third resource and a fourth resource separately according to the first scheduling priority and the second scheduling priority; and
allocate the third resource to the waiting task group, and allocate the fourth resource to the task group.

13. The computing device according to claim 9, wherein the processing component is specifically configured to create, in response to the task processing request, a plurality of task groups, and wherein the processing component is specifically configured to:
when determining that the remaining resource of the container management system satisfies a running resource requirement of at least one task group of the plurality of task groups, send the container group in the at least one task group to the scheduling queue of the container management system.

14. The computing device according to claim 9, wherein after creating the task group, the processing component is further configured to configure a scheduling pausing label for the container group in the task group;
when determining that the remaining resource of the container management system satisfies the running resource requirement of the task group, the processing component is further configured to remove the scheduling pausing label configured for the container group in the task group; and
the processing component is specifically configured to send the container group in the task group to the scheduling queue of the container management system in response to the scheduling pausing label being removed.

15. The computing device according to claim 14, wherein when detecting that the remaining resource of the container management system does not satisfy the running resource requirement of the task group, the processing component is specifically configured to configure the scheduling pausing label for the container group in the task group.

16. A computing device, comprising a processing component and a storage component, wherein
the storage component stores one or more computer instructions; and the one or more computer instructions are used for being invoked and executed by the processing component, to implement the task scheduling method according to claim 8.

17. A non-transitory computer storage medium, storing a computer program, wherein when the computer program is executed by a computer, the task processing method according to claim 1 is implemented.

18. The non-transitory computer storage medium according to claim 17, wherein the task processing method further comprises:
placing the created and generated task group in a queuing queue of the database system, wherein
the detecting whether a remaining resource of a container management system satisfies a running resource requirement of the task group comprises:
searching the queuing queue for determining whether there currently exists a waiting task group waiting to be scheduled, wherein a creation time point of the waiting task group is earlier than that of the task group;
in response to the waiting task group waiting to be scheduled currently existing, determining a first scheduling priority of the waiting task group and a second scheduling priority of the task group; and
when the second scheduling priority is higher than the first scheduling priority, detecting whether the remaining resource of the container management system satisfies the running resource requirement of the task group.

19. The non-transitory computer storage medium according to claim 18, wherein the task processing method further comprises:
allocating a first resource that satisfies the running resource requirement to the task group, to run, after the container group in the task group is scheduled to the node of the container management system, the container group by using the first resource.

20. A non-transitory computer storage medium, storing a computer program, wherein when the computer program is executed by a computer, the task scheduling method according to claim 8 is implemented.
